(19) United States
(12) Patent Application Publication
(10) Pub. No.: US 2022/0203291 A1
(43) Pub. Date: Jun. 30, 2022

(54) MONITORING, CONTROL, AND FAULT SELF-DIAGNOSIS SYSTEM AND METHOD FOR MEDICAL OXYGEN PLANT GENERATOR

(71) Applicants: Manuel Alejandro Sánchez Castro, Mexico City (MX); Pamela Serna Mendiburu, Monterrey (MX)

(72) Inventors: Manuel Alejandro Sánchez Castro, Mexico City (MX); Pamela Serna Mendiburu, Monterrey (MX)

(21) Appl. No.: 17/137,636

(22) Filed: Dec. 30, 2020

(51) Int. Cl. B01D 53/053; B01D 53/26; B01D 53/04; B01D 45/16; B01D 50/00

(52) U.S. Cl. CPC B01D 53/053; B01D 53/26; B01D 53/0446; B01D 45/16; B01D 50/002; B01D 2259/4533; B01D 2257/102; B01D 2256/12; B01D 2259/40007; B01D 2259/403; B01D 2253/108

(57) ABSTRACT

A monitoring and control system of a molecular sieve oxygen plant generator comprising a PLC controller installed in an oxygen generator, which in turn is connected with an oxygen generator and an air storage tank. The system allows the generation of oxygen in situ and the control and monitoring is remotely controlled. The system comprises artificial intelligence for the monitoring, control and fault self-diagnosis.

### TECHNICAL FIELD

The present invention relates to control systems and methods for oxygen generation. More particularly, the present invention relates to a molecular sieve oxygen plant generator. Although the invention has broad application, it is principally aimed at use in medical settings, such as hospitals and medical clinics, as it is focused on controlling molecular sieve oxygen plant generators and reducing the fault-rate of associated equipment.

### BACKGROUND OF THE INVENTION

Molecular sieve oxygen plant generator control systems relate to the field of oxygen control devices, monitoring systems and artificial intelligence. The interest in those systems has increased considerably during the last decades, particularly due to the consequences of treating patients without following good manufacturing practices and international regulations about medical gases, causing serious injuries or deaths.

Several international regulations have been implemented to guide and assist medical gases manufacture, since they are considered as finished pharmaceuticals and must comply with the quality, purity and concentration required by the concerned regulations.

Among the different medical gases used in medical centers, oxygen is one of the most required for clinical treatment. The most popular methods for producing medical oxygen are: cryogenics, membrane filter technology, electrolysis and pressure swing adsorption (PSA). PSA is a better option in terms of running costs for purity levels slightly less than 100% and for hospital volume demand in comparison with other techniques. In addition, the implementation of medical oxygen plant generators is convenient for the manufacture in-situ and fast distribution in medical care centers.

At present, different technologies and processes have been developed for producing medical oxygen in-situ. Technology developments go from monitoring and control systems in oxygen plant generators with molecular sieve PSA, to methods of fault-rate prediction and self-tuning systems.

For example, document CN201040719Y (2008) entitled “Control system for six-tower oxygen generator” describes a method for achieving the flexible control of medical oxygen production. However, it does not allow the monitoring or control of impurities that can be present in medical gases produced by PSA technology, such as carbon monoxide, carbon dioxide, nitrogen oxide, nitrogen dioxide, sulfur dioxide and oil traces. This is primarily because it is aimed to fulfill the international regulations that require monitoring and controlling the concentration of impurities, besides medical oxygen.

Before using a medical oxygen plant generator, the installer is obliged to adopt all the measures of good installation for the air compressor to respect each country's law. Therefore, present invention provides a control system which is used as one that fulfill European Pharmacopeia and is flexible according to the plant needs.

Document CN205973783U (2017) entitled “Medical molecular sieve oxygen generation equipment automatic control and remote monitoring system” describes automatic control and remote monitoring in real-time, the oxygen plant generator configuration and fault prediction system; providing a control method that allows to increase the efficiency and prolongs the molecular sieve life. The processed data can be visualized on a central computer or on a touch screen. The same refers to a control system and remote monitoring system for the control of real-time operating state, promotes system oxygen station steady operation and improves staffs efficiency. However, it does not allow the assessment of regulated impurities that can be present on medical gases.

The present invention seeks to solve the technical problem of the prior art, providing low cost, flexible control system of the oxygen plant generator and the concentration monitoring of gas impurities, such as carbon monoxide, carbon dioxide, nitrogen oxide, nitrogen dioxide, sulfur dioxide, oil and water traces. The method of present invention was developed in the following scheme: PLC controllers are running state detector, two oxygen generators, oxygen valve, drain valve, alarm, touch screen are connected, the oxygen column host running state detector is connected; oxygen concentration transmitter, pressure transmitter oxygen A/D converter and PCL control are respectively connected.

### SUMMARY OF THE INVENTION

The following summary is provided to introduce a selection of concepts in a simplified form that are further described in the detailed description. This summary is not intended to identify key features or essential feature of the claimed subject matter, nor is it intended to be used to limit the scope of the claimed subject matter.

The present invention refers to a control method in PSA medical oxygen plant generator, to increase the efficiency and reduce the fault presence in-plant. The method realizes the monitoring on real-time of oxygen flow and controls the distribution of this gas. The system acquires data during the operation and detects critical variables that have higher influence in the correct functioning, realizing a fault-prediction test, emits alarms when some parameters are outside the values considered by the European Pharmacopeia (or other applicable standard) and allows the turn-off of the oxygen plant.

The method includes a PLC controller and running state detector. The control system utilizes: a master generator connected with two oxygen generators, an air inlet pressure transmitter, an adsorption pressure transmitter, an oxygen concentration transmitter, an oxygen outlet pressure transmitter, an oxygen outlet valve, a drain valve, an impurities concentration transmitter, an ambient temperature transmitter, a humidity transmitter, all through an A/D converter; respectively connected with the alarm system and an touch screen. The PLC controller is respectively connected with a freeze drier, an air compressor, and pressurization equipment through relays.

The present invention applies to medical oxygen equipment, to achieve the automatic operation of process control, remote monitoring, fault diagnosis and self-correcting, on-line adjustment process parameters, thereby effectively improving the effectiveness use of the oxygen plant, facilitating safe, reliable and economical medical oxygen equipment to solve the problem of quickly in-situ preparation of the local hospital for medical oxygen, as well as the fulfillment of the concerned regulations related with the monitoring and control of medical oxygen quality.

Although the invention is illustrated and described herein as embodied in connection with oxygen generation for medical facilities, it is nevertheless not intended to be limited to only the details shown, since various modifications and structural changes may be made therein without departing from the spirit of the invention and within the scope and range of equivalents of the claims.

These and other objects, features, and advantages of the present invention may be more clearly understood and appreciated from a review of ensuing detailed description of the preferred and alternate embodiments and by reference to the accompanying drawings and claims.

### BRIEF DESCRIPTION OF THE DRAWINGS

FIG. 1 is a block diagram showing the principal features of the present invention's system and method.

### DETAILED DESCRIPTION OF THE EMBODIMENTS OF THE INVENTION

While the present invention will be described more fully hereinafter with reference to the accompanying drawings, in which an embodiment of the present invention is shown, it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

Below with reference to the present invention, the FIGURES present the invention, from which one skilled in the art may deduce embodiments without getting away from the spirit of the invention.

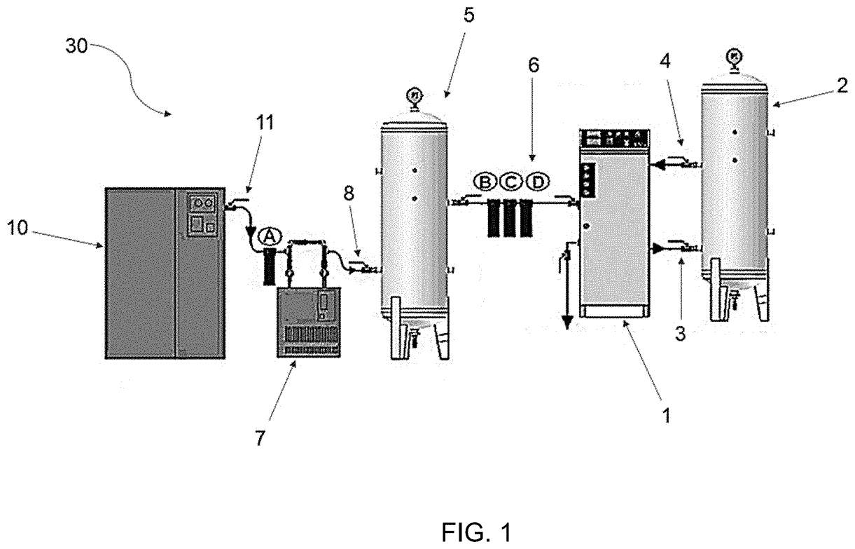

FIG. 1 discloses the monitoring, control, and fault self-diagnosis system 30 of present invention comprising an oxygen generator 1 connected to an oxygen regulation tank 2 through an outlet valve 3 and an oxygen valve 4. The oxygen generator 1 is also connected to an air storage tank 5 via a line connector 6 containing multiple modules B, C, and D between said storage tank 5 and the oxygen generator 1. It is worth noting that in some embodiments of the invention there are multiple oxygen generators connected to the oxygen regulation tank 2 and the air storage tank 5.

An air dryer 7 is connected to the air storage system 5 through a dryer valve 8 and to an air compressor 10 via a compressor valve 11. The air compressor 10 comprising a filter (not shown) located in the inlet thereof for filtering any impurity from the atmosphere or environment. Besides, there is a cyclone filter A located between the air compressor 10 and the air dyer 7, wherein the cyclone filter A withdraws or filters oil residues. The air compressor 10 provides air from the atmosphere and pressurizes the same before transmitting said pressurized air to the air dyer 7.

The air dryer 7 withdraws the moisture from the pressurized air coming from the atmosphere maintaining a temperature equal or less than 5° C., wherein the dried air is stored in the storage tank 5. Once the dried air is inside the storage tank, the same is passed through the line connector 6, wherein there is a process of separation of oxygen which is achieved through modules B, C and D. Said modules A, B, and C contain zeolite which provides molecular sieve filtering (through a molecular sieve filter) of the nitrogen contained in the dried air and the line connector 6 provides only oxygen gas, while the nitrogen is released through an nitrogen outlet valve or a similar releasing device.

The oxygen generator 1 comprises a control and measurement system comprising digital devices for monitoring the purity of the oxygen and the flow of the oxygen gas at an outlet module controlled via a Programmable Logic Controller (PLC) running in a state detector, the PLC is connected to a A/D converter for converting analogical signal coming from different sensors positioned in the oxygen generator 1, valves 3 and 4, oxygen regulation tank 2 and different parts of system 30 to digital signals.

The PLC comprising a processor and one or more computer memory devices interoperably coupled with PLC and having tangible, non-transitory, machine-readable media storing one or more instructions that, when executed by the one or more computers devices, perform one or more operations comprising:

a) beginning the control system;

b) entering a parameter setting process;

c) starting open only a limited number of procedures;

d) determining whether a process parameter adjustment is needed, and provide an adjustment or displaying a status and fault detection displaying program;

e) determining whether there is a fault, and repairing the same, and in case a repair is not performed, a policing program shuts down the procedure or determines a shutdown when a fault does not exist;

f) in case of failure to perform a fault repair the self-repair program, then determines whether to shut down, if the election Optional shutdown program is executed, if the user choose not to shut the oxygen pressure storage tank is performed P. Found “Oxygen storage tank limit set pressure p. H is determined;

g) an oxygen storage tank if the measured pressure p. “Oxygen storage tank limit set pressure p. h is not established status and fault detection and display program is executed; if p. “Oxygen storage tank limit set pressure p. H stand establishment procedure is performed; and an oxygen storage tank for the measured pressure p. “The oxygen storage tank limit set pressure Pd Judgment, the oxygen storage tank if the measured pressure p. “The oxygen storage tank limit set pressure p. Set up booting process is executed; if the oxygen pressure storage tank Found p. “The oxygen storage tank limit set pressure PA Not established status and fault detection and display program is executed.

With the above features, the system 30 of the present invention provides a monitoring, control and fault self-diagnosis system which also contains artificial intelligence as well as relevant statistics that are shared with operators and registered users.

System 30 may be monitored via Internet since the PLC and other elements may be connected to a VLAN or a network via a specialized database containing artificial intelligence, including Internet, to remote control of the system from a different region of the world, wherein the system is only used by registered users through a security system.

Accordingly, it will be understood that several embodiments of the present invention have been disclosed by way of examples and that other modifications and alterations may occur to those skilled in the art without departing from the scope and spirit of the appended claims

We claim:

1. A monitoring, control, and fault self-diagnosis oxygen generation system comprising:
an air compressor;
an air dyer connected to the air compressor;
an oxygen generator connected to an air storage tank and to an oxygen regulation tank, wherein the air storage tank is connected to the air dryer;
wherein the air storage tank and the oxygen regulation tank are connected via a line connector; and
wherein the oxygen generator comprises a Programmable Logic Controller (PLC) comprising a processor and one or more computer memory devices interoperably coupled with the PLC and having tangible, non-transitory, machine-readable media storing one or more instructions that, when executed by the one or more computers devices, perform one or more operations comprising:
a) beginning the control system;
b) entering a parameter setting process;
c) starting a limited number of procedures;
d) determining whether a process parameter adjustment is needed, and providing an adjustment of the process parameter, or executing a status and fault detection displaying program;
e) determining whether there is a fault, and repairing the same, and in case a repair is not performed, a policing program shuts down the procedure or determines a shutdown when a fault does not exist;
f) in case of failure to perform a fault repair self-repair program, then determine whether to shut down, if the election Optional shutdown program is executed, if the user choose not to shut the oxygen pressure storage tank is performed P. Found “Oxygen storage tank limit set pressure p. H is determined;
g) an oxygen storage tank if the measured pressure p. “Oxygen storage tank limit set pressure p. h is not established status and fault detection and display program is executed; if p. “Oxygen storage tank limit set pressure p. H stand establishment procedure is performed; and an oxygen storage tank for the measured pressure p. “The oxygen storage tank limit set pressure Pd Judgment, the oxygen storage tank if the measured pressure p. “The oxygen storage tank limit set pressure p. Set up booting process is executed; if the oxygen pressure storage tank Found p. “The oxygen storage tank limit set pressure PA Not established status and fault detection and display program is executed.

2. The system according to claim 1, wherein the air compressor comprises an inlet filter.

3. The system according to claim 1, wherein a cyclone filter is located between the air compressor and the air dryer.

4. The system according to claim 1, wherein the line connector comprises multiple modules.

5. The system according to claim 4, wherein the multiple modules are a molecular sieve filters based on zeolite adapted to trap nitrogen molecules.

6. The system according to claim 1, wherein the system comprises artificial intelligence for the monitoring control and fault self-diagnosis.

7. The system according to claim 1, wherein the system comprises an online database and it is remotely controlled.
